(19) United States
(12) Patent Application Publication
(10) Pub. No.: US 2024/0140364 A1
(43) Pub. Date: May 2, 2024

(54) WINDSHIELD WIPER SYSTEM FOR A VEHICLE

(71) Applicant: Robert Bosch GmbH, Stuttgart (DE)

(72) Inventor: Michael Schaeuble, Vaihingen An Der Enz (DE)

(21) Appl. No.: 18/495,002

(22) Filed: Oct. 26, 2023

(30) Foreign Application Priority Data
Oct. 28, 2022 (DE) 10 2022 211 472.8

(51) Int. Cl. B60S 1/48; B60S 1/08; B60S 1/52

(52) U.S. Cl. CPC B60S 1/485; B60S 1/0844; B60S 1/0896; B60S 1/486; B60S 1/524

(57) ABSTRACT

A windshield wiper system for a vehicle. In one example, the windshield wiper system includes a windshield wiper having a wiper arm, a wiper blade, a wiper arm drive and a washing nozzle, and an evaluation unit. The washing nozzle is configured to be moved along a windshield and to dispense a washing liquid The evaluation unit is configured to determine a partial area of the windshield of the vehicle to be cleaned The partial area is an area which can be reached by the wiper blade to control the wiper arm drive to move the wiper blade from a parking position of the wiper blade to the partial area and to activate the dispensing of the washing liquid upon reaching the partial area and to control the wiper arm drive to only sweep the partial area for cleaning by means of an oscillating movement.

### BACKGROUND OF THE INVENTION

The present invention relates to a windshield wiper system for a vehicle and in particular to a windshield wiper system with particularly low washing liquid consumption.

Windshield wiper systems for vehicles are known in the prior art in which a washing liquid is dispensed via nozzles, which are arranged in the area of the wiper arms of the windshield wiper system and which are moved together with the wiper arms over a surface to be cleaned, such that the washing liquid can be applied in an optimized manner independently of current boundary conditions (e.g., a height of a current airflow, a position at which there is soiling to be cleaned, etc.).

From the prior art, sensors for vehicles are also known (e.g., cameras, lidar sensors, radar sensors, ultrasonic sensors, etc.), which are used for environmental detection, for example, to provide driver assistance systems and/or systems for (partially) automated driving with necessary environmental information.

Furthermore, sensors for vehicles are known that detect a current outside temperature and/or amount of precipitation (e.g., by means of a rain sensor) in the vicinity of the vehicles.

### SUMMARY OF THE INVENTION

The present invention proposes a windshield wiper system for a vehicle, by which particularly low washing liquid consumption can be achieved.

The windshield wiper system comprises a windshield wiper with at least one wiper arm, at least one wiper blade, at least one wiper arm drive (preferably based on a rotating motor, in particular an electric motor) and at least one washing nozzle. Furthermore, the windshield wiper system comprises an evaluation unit, which is configured as, for example, an ASIC, FPGA, processor, digital signal processor, microcontroller, or the like, and which is configured as, for example, a separate component of the windshield wiper system and/or is integrated into an existing component of the windshield wiper system and/or another system of the vehicle.

The evaluation unit is preferably connected in terms of information technology and/or electrically to the wiper arm drive and/or to a control unit of the wiper arm drive and/or to a device configured to dispense a washing liquid via the nozzle.

The washing nozzle is arranged in the area of the wiper blade (for example, at a top or bottom side of the wiper blade or in the middle of the wiper blade) and is configured in this manner to be moved along a windshield of the vehicle by means of the wiper arm and dispense a washing liquid in the vicinity of the wiper blade. For this purpose, for example, the nozzle is arranged on the wiper blade itself and/or in an area on the wiper arm where the wiper arm is connected to the wiper blade. In addition, it is conceivable that the nozzle is composed of a plurality of individual nozzles arranged, for example, along the wiper blade. For example, the windshield is a front windshield or rear windshield of the vehicle, wherein the vehicle may be, among other things, a road vehicle (e.g., a motor vehicle, car, van, or truck) or a rail vehicle or an airplane/aircraft and/or a watercraft.

The evaluation unit is configured to determine a partial area of the windshield of the vehicle to be cleaned (i.e., a zone to be cleaned) by means of the windshield wiper system, wherein the partial area is a partial area of an overall wiping area which can be reached by the wiper blade.

The evaluation unit is further configured to control the wiper arm drive in order to move the wiper blade from an area of a parking position of the wiper blade to the determined partial area of the windshield. The parking position of the wiper blade is in particular to be understood as a position in which the wiper blade is arranged substantially horizontally at a lower edge of the windshield, wherein generally deviating parking positions of the wiper blade are also possible. Ideally, the parking position of the wiper blade is a position at which a field of view of a user of the vehicle is not influenced or only influenced to a small extent and/or at which as little air resistance as possible is caused by the wiper arm and the wiper blade during travel. The area of the parking position is to be understood as an area that corresponds, for example, to an angular deviation (i.e., a rotation angle of the wiper arm) from the actual parking position by a value of up to 5°, up to 10°, up to 15° or more, wherein this angular deviation is preferably to be considered in the direction of a starting direction of the wiper blade from the parking position. In addition to an angular deviation, which defines the area, it is alternatively possible to consider a parallel offset to the parking position, etc. for this purpose.

The evaluation unit is further configured to activate the dispensing of the washing liquid upon reaching the partial area and to control the wiper arm drive in order to exclusively sweep the partial area for cleaning by means of an oscillating movement. That is to say, the wiper blade is advantageously guided at least once from a first end of the partial area to a second end of the partial area and back to the first end of the partial area without completely sweeping the overall wiping area.

This advantageously achieves that only the dirty area is selectively swept, which results, on the one hand, in a reduction in the consumption of a washing liquid, as the washing liquid is dispensed only within the partial area and, on the other hand, to a cleaning of the windshield of the vehicle taking place particularly quickly, whereby a view of a user of the vehicle (in particular of a driver) is only affected by the wiper arm and the wiper blade for a particularly short time. The reduced consumption of the washing liquid in accordance with the invention makes it possible, among other things, to increase an interval in which a reservoir for the washing liquid must be refilled.

This explicitly does not exclude that after the at least one oscillating movement of the wiper blade within the partial area to be cleaned, an area of the windshield that deviates from the partial area is cleaned, which is a further partial area or the overall wiping area of the windshield. Such a combination can be usefully applied, for example, if the soiling is a particularly difficult to remove (e.g., dried-on) soiling, which is initially only partially removed and/or dissolved within the partial area while saving a washing liquid according to the invention, and is completely removed in a subsequent overall cleaning of the overall wiping area.

The dependent claims specify preferred embodiments of the invention.

In a particularly preferred embodiment of the present invention, the evaluation unit is additionally configured to determine a degree of wetting of the windshield by a liquid (e.g., rain droplets and/or spray water from a vehicle ahead, etc.) in the area of the parking position of the wiper blade. This is preferably done on the basis of a sensor system coupled with the evaluation unit in terms of information technology and/or on the basis of an external source of information. The evaluation unit is also configured to activate dispensing of a washing liquid by means of the washing nozzle in the area of the parking position of the wiper blade and subsequently to deactivate it within the area of the parking position when the degree of wetting is below a predefined threshold level and is further configured not to activate the dispensing of the washing liquid in the area of the parking position if the degree of wetting corresponds to at least the threshold level. The threshold value is preferably defined as a function of a frictional resistance between the wiper blade and the windshield, which must at least be undershot so that the windshield wiper, in particular the wiper blade and/or a wiper rubber of the wiper blade and/or the wiper arm drive does not experience any damage and/or an undesirably high level of wear due to a “dry wiping”. In a case in which, for example, rain drops are present to a sufficient extent in the area of the parking position, a correspondingly low friction between the wiper blade and the windshield is to be expected, such that the wiper arm can be moved to the partial area to be cleaned without additional dispensing of washing liquid in the area of the parking position, while the wetting by raindrops simultaneously ensures that a wiper arm material (in particular a wiper rubber of the wiper arm) is protected during the movement. In a case in which the windshield is not or only slightly wetted, movement of the wiper arm to the partial area to be cleaned would be accompanied by a correspondingly large load on the wiper arm material, which is why the evaluation unit is configured in this case to perform wetting in the area of the parking position by means of the washing liquid. Preferably, the evaluation unit is configured to adjust an amount of the washing liquid to be dispensed in this case as a function of a possible low degree of wetting (which is below the threshold value) so as not to consume an unnecessary amount of washing liquid. The threshold value and/or the dispensed amount of the washing liquid are preferably set such that wetting in the area of the parking position is sufficient to ensure sufficient lubrication of the wiper blade until reaching the partial area to be cleaned. Because an active wetting by the windshield wiper system is only performed as needed and only in the area of the parking position, the consumption of the washing liquid can be further reduced.

In a further advantageous embodiment of the present invention, the evaluation unit is configured to deactivate the dispensing of the washing liquid in the area of the parking position of the wiper blade after a predefined time and/or after the wiper arm has swept over a predefined angle in the area of the parking position and/or to adjust a pressure at which the washing liquid is dispensed from the washing nozzle as a function of a direction of movement of the wiper blade and/or a type and/or an extent of soiling present. For example, a type of soiling is intended to mean a level of soiling and/or a material underlying the soiling. Depending on the type and/or extent of the soiling, it can be removed in an optimized manner by adjusting the pressure of the washing liquid accordingly. The degree of soiling is preferably determined based on a sensor system of the vehicle, in particular based on a sensor system which is configured to directly detect the soiling.

Advantageously, the degree of wetting of the windshield in the area of the parking position is determined based on a rain sensor and/or a camera and/or a sensor (e.g., a lidar sensor and/or an ultrasonic sensor and/or a radar sensor, etc.). For example, the rain sensor and/or the camera are arranged in an upper area region of the windshield in the interior of the vehicle and are oriented in a forward direction of travel of the vehicle, without being limited thereto. Alternatively or additionally, the degree of wetting is determined based on weather data, which can in particular be received via a wireless communication link of the vehicle in the vehicle and which are provided, for example, by an online weather service and/or a radio transmitter, etc. Further alternatively or additionally, it is possible to determine the degree of wetting based on a level of current consumption of the wiper arm drive and/or a driving speed of the vehicle. The current consumption can be determined, for example, by moving the wiper arm slightly out of the parking position within the area of the parking position by controlling the wiper arm drive in a suitable manner by the evaluation unit. Based on the current consumption measured by the wiper arm drive, which correlates with a frictional resistance between the wiper blade and the windshield, a potential wetting of the windshield and/or the degree of wetting can thus be estimated by the evaluation unit. The speed of the vehicle can be in particular advantageously considered in connection with the evaluation of the current consumption of the wiper arm drive, as the current consumption additionally depends on an existing headwind, which increases the frictional resistance by increasing the pressure of the wiper blade on the windshield. In addition, it may be useful to additionally consider a current angular position of the wiper arm, as the influence of the headwind additionally depends on the angular position.

For example, the partial area to be cleaned is a predefined area, such as an area of a camera and/or another sensor, which is arranged behind the windshield, for example in the interior of the vehicle. Here, it is possible, among other things, to clean the predefined area at a predefined time interval and/or according to a current need. Alternatively or additionally, the partial area to be cleaned is an area determined on the basis of a sensor system, wherein the sensor system is preferably a sensor system of the vehicle, which can detect at least one viewing area of the windshield relevant to the driver of the vehicle. Based on such a sensor system, a position of soiling on the windshield can be determined accordingly so that the partial area can be defined as a function of the determined position. Alternatively or additionally, the evaluation unit is configured to determine a size of the partial area to be cleaned as a function of an extent and/or type of a present soiling. Advantageously, the partial area for this is defined in a predefined manner to be larger than the actual extent of the soiling in order to ensure reliable removal of the entire soiling. For this purpose, for example, an angle range of 5° to 15° in both directions of movement of the wiper arm is selected starting from a central position of the soiling.

In a further advantageous embodiment of the present invention, the evaluation unit is configured to move the wiper blade back and forth multiple times (i.e., at least two times) within the partial area by means of a control of the wiper arm drive, without exiting the partial area and/or to activate the dispensing of the washing liquid within the partial area permanently and/or multiple times (e.g., intermittently) and/or to adjust a frequency of sweeping the partial area using the wiper blade and/or a frequency and/or a duration of an activation of the washing nozzle within the partial area and/or a wiping speed of the wiper blade depending on predefined parameters (e.g., a predefined sensor position which is to be cleaned at a predefined interval of 30 minutes, etc.) and/or a type and/or extent of soiling present in the partial area and/or a sensor-determined progress of the cleaning process of the partial area (e.g., by means of a sensor, for which a partial area of the windshield to be cleaned is defined and/or by means of a sensor deviating therefrom) and/or a type and/or an amount of precipitation present (e.g., rain, snow) and/or an outside temperature and/or a driving speed and/or a position of the soiling on the windshield.

Further advantageously, the washing nozzle of the windshield wiper is a first washing nozzle, while the windshield wiper comprises a second washing nozzle arranged on an opposite side of the first washing nozzle in the area of the wiper blade, such that the windshield wiper is configured to dispense a washing liquid both in and against a current direction of movement of the wiper blade based on the two washing nozzles. Further, the evaluation unit is configured to individually activate the first washing nozzle and the second washing nozzle as a function of a respective direction of movement of the wiper blade and/or a type and/or an extent of soiling and/or individually adjust a dispensing pressure of the washing liquid. In this way, the cleaning of the partial area to be cleaned can be carried out in a more targeted manner and in particular with minimum washing liquid consumption. For example, it may be advantageous to set a higher dispensing pressure from the nozzle which is aligned in the direction of the current direction of movement of the wiper blade, in order to loosen soiling by means of the higher pressure, while the other nozzle, which is arranged in the opposite direction to this, can be operated at a lower pressure in order to apply as much washing liquid as possible in the partial area to be cleaned and leave it there, so that soaking of the dirt is effected.

Particularly preferably, the windshield wiper system is configured to perform the individual activation of the first washing nozzle and the second washing nozzle based on separate washing liquid pumps and/or separate valves in respective feed lines of the washing nozzles.

Further preferably, the wiper comprises a further wiper arm having a further wiper blade, having a further wiper arm drive, and having a further washing nozzle, which is, for example, a wiper arm for one driver side, while the wiper arm described above is provided, for example, for a driver side of a windshield of the vehicle. In this case, the evaluation unit is configured to control the further wiper arm drive and the further washing nozzle to clean a further partial area, wherein this is possible analogously to the description above for the initially described wiper arm. It should be noted that the wiper arm drive described above and the further wiper arm drive may be one and the same wiper arm drive, for example, in that both wiper arms are driven together via a so-called “towed” windshield wiper via a single motor. Particularly advantageously, however, these are designed as individually controllable, separate wiper arm drives.

In a further advantageous embodiment of the present invention, the evaluation unit is configured to move the wiper arm of the windshield wiper, in whose cleaning area no cleaning is currently required, to an upper helical position (i.e., a position in which a reversal of movement of the wiper arm occurs at the lateral edge of the windshield) by means of a control of the corresponding wiper arm drive and to leave it there until the cleaning of the windshield by the wiper arm is completed. This offers the particular advantage that after the cleaning of the partial area has been completed, the windshield is finally dried by returning the wiper arm held in the helical position.

### BRIEF DESCRIPTION OF THE DRAWINGS

Exemplary embodiments of the invention are described in detail hereinafter with reference to the accompanying drawings. The figures show:

FIG. 1 a schematic view of a first embodiment of a windshield wiper system according to the invention;

FIGS. 2a to 2h an exemplary cleaning sequence for the windshield wiper system according to the invention;

FIG. 3 a schematic view of a second embodiment of a windshield wiper system according to the invention; and

FIG. 4 a schematic view of a third embodiment of a windshield wiper system according to the invention.

### DETAILED DESCRIPTION

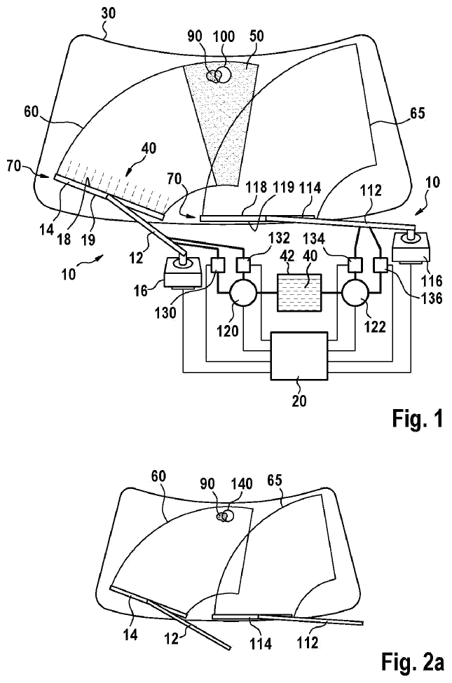

FIG. 1 shows a schematic view of a first embodiment of a windshield wiper system according to the invention for a vehicle, wherein the windshield wiper system is provided here for a front windshield 30 of the vehicle.

For cleaning a passenger side front windshield 30, the wiper system comprises a windshield wiper 10 with a first wiper arm 12, which is mechanically coupled to a first wiper blade 14, which in turn comprises a first washing nozzle 18 and a second washing nozzle 19, wherein the first washing nozzle 18 and the second washing nozzle 19 are arranged on opposite sides of the first wiper blade 14. The first wiper arm 12 is mechanically coupled to a first wiper arm drive 16, which is configured to move the first wiper arm 12 and the first wiper blade 14 by means of a rotational movement within a first overall wiping area 60 over the front windshield 30.

The windshield wiper system further comprises a second wiper arm 112 mechanically coupled to a second wiper blade 114, which in turn comprises a third washing nozzle 118 and a fourth washing nozzle 119, wherein the third washing nozzle 118 and the fourth washing nozzle 119 are arranged on opposite sides of the second wiper blade 114 respectively. The second wiper arm 112 is mechanically coupled to a second wiper arm drive 116, which is configured to move the second wiper arm 112 and the second wiper blade 114 by means of a rotational movement within a second overall wiping region 65 over the front windshield 30.

The windshield wiper system further comprises a washing liquid reservoir 42 connected via a line to a first pump 120, wherein the first pump 120 is configured to draw in a washing liquid 40 stored in the washing liquid reservoir 42 and to transport it in the direction of a first valve 130 and a second valve 132, which are each configured to allow and interrupt a flow of the washing liquid 40. The first valve 130 is connected to the first nozzle 18 via a line, while the second valve 132 is connected to the second nozzle 19 via a line.

The washing liquid reservoir 42 is also connected to a second pump 122 via a line, which is configured to draw in the washing liquid 40 stored in the washing liquid reservoir 42 and to transport it in the direction of a third valve 134 and a fourth valve 136, which are each configured to allow and interrupt a flow of the washing liquid 40. The third valve 134 is connected to the third nozzle 118 via a line, while the fourth valve 136 is connected to the fourth nozzle 119 via a line.

The windshield wiper system also comprises an evaluation unit 20 configured as a microcontroller, which is electrically connected to the first wiper arm drive 16, the second wiper arm drive 116, the first pump 120, the second pump 122, the first valve 130, the second valve 132, the third valve 134, and the fourth valve 136, and configured to individually control all of the above-mentioned components.

Moreover, the evaluation unit 20 is connected to a camera 100 of the vehicle in terms of information technology, wherein the connection is not shown here for purposes of clarity. The camera 100 is arranged in the interior of the vehicle behind the front windshield 30, wherein a field of view of the camera 100 is oriented in the forward direction of travel of the vehicle.

In the field of view of the camera 100, there is soiling 90 which reduces a detection ability of the camera 100, which is a camera 100 of an environment detection system (not shown) of the vehicle.

Based on the above configuration, the evaluation unit 20 is configured to determine a partial area 50 of the front windshield 30 to be cleaned, which here falls within the partial area of an overall wiping area 60 which can be reached by the first wiper blade 14, in that the evaluation unit 20 receives information from the camera 100 about the restricted field of view due to soiling and determines the partial area 50 to be cleaned based on position information of the camera 100 stored in the evaluation unit 20. The determination is made here in such a way that, starting from a center of the soiling 90, a deflection angle of the wiper blade of 10° in each case is determined for the area 50 to be cleaned as a function of an extent of the soiling 90 in both directions of movement of the first wiper blade 14.

On this basis, the evaluation unit 20 is configured to control the first wiper arm drive 16, in order to move the wiper blade 14 from an area of a parking position 70 of the first wiper blade 14 to the determined partial area 50 of the front windshield 30 and activate the dispensing of the washing liquid 40 upon reaching the partial area 50 by appropriately controlling the first pump 120, the first valve 130, and the second valve 132. In addition, the evaluation unit 20 is configured to control the first wiper arm drive 16 in order to only sweep the partial area 50 for cleaning by means of an oscillating movement.

It should be noted that the evaluation unit 20 is configured to carry out a cleaning of the driver's side of the front windshield 30 analogous to the above description if there is further soiling 90 in the area of the second overall wiping area 65.

It should also be noted that the soiling 90 may also be present at any position in the first overall wiping area 60 and/or the second overall wiping area 65, the specific position of which can be determined, for example, by means of a further sensor system of the vehicle, which is configured to detect the first overall wiping area 60 and/or the second overall wiping area 65.

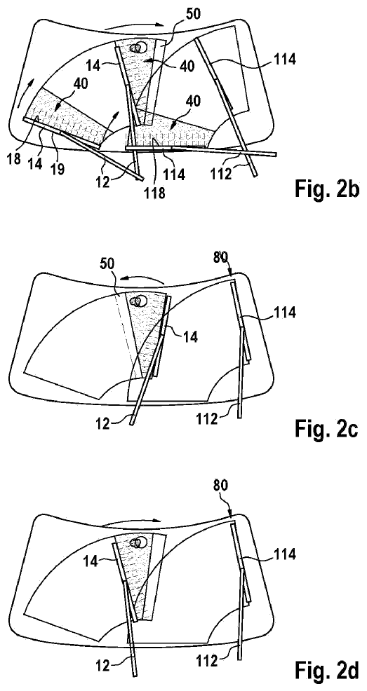

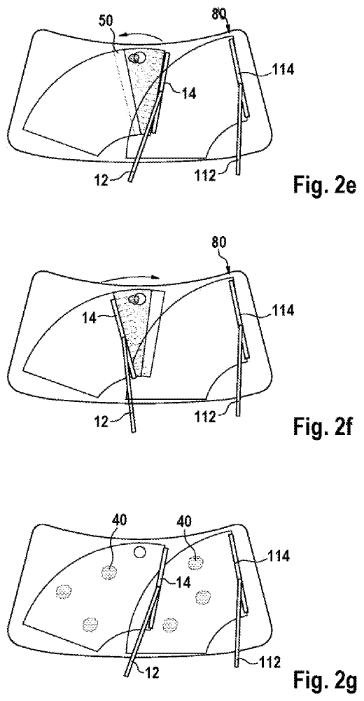

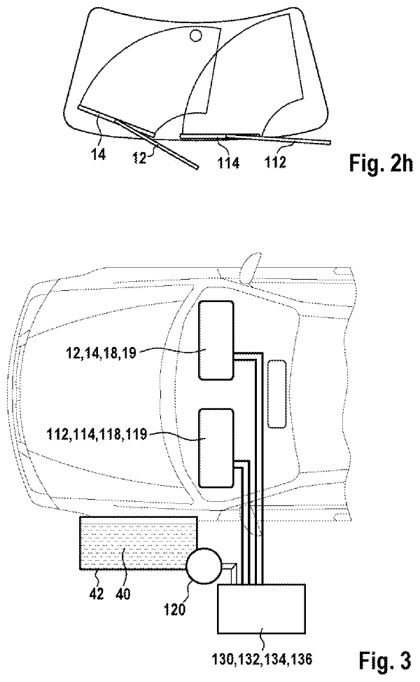

FIGS. 2a to 2h show an exemplary cleaning sequence for the windshield wiper system according to the invention. It should be noted that the underlying design of the windshield wiper system shown here substantially corresponds to the windshield wiper system described in FIG. 1, wherein some components described in FIG. 1 are omitted in terms of a clearer illustration and are referred to in this respect to FIG. 1. The camera 100 described in FIG. 1 is replaced herein by a rain sensor 140 of the vehicle. The following cleaning sequence is performed by means of the evaluation unit 20 described in FIG. 1 based on a computer program.

FIG. 2a shows a base position of the wiper arms 12, 112 and their wiper blades 14, 114 prior to performing the cleaning sequence. In the area of the rain sensor 140, there is soiling 90, which is determined by means of the evaluation unit 20.

FIG. 2b shows a short spray of the first nozzle 18 of the first wiper blade 14 and the third nozzle 118 of the second wiper blade 114 to wet the windshield 30 in an upward direction of the first wiper arm 12 and the second wiper arm 112 by means of a washing fluid 40, to be able to perform a subsequent movement of the two wiper arms 12, 112 with a low frictional resistance on the windshield 30. The need to perform spraying here is due to the fact that the evaluation unit 20 has determined, based on the rain sensor 140, that the windshield 30 is not wet. The spray is terminated before exiting the area of the parking position 70 of the two wiper arms 12, 112 (shown in FIG. 1) to save a washing liquid 40 used.

FIG. 2b also shows a downstream condition in which the first wiper blade 14 has reached a first end of the partial area 50 to be cleaned, and in which the second wiper blade 114 is moved in the direction of an upper helical position 80 (see FIG. 2c) of the second wiper blade 114. Upon reaching the second partial area 50, washing liquid 40 is dispensed again by means of the first nozzle 18 in the current direction of movement of the wiper blade 14 (see arrow) to clean the partial area 50.

FIG. 2c shows a state in which the first wiper blade 14 has reached a second end of the partial area 50 to be cleaned and at this position undergoes a movement reversal in order to perform an oscillating movement within the partial area 50. Washing liquid 40 is dispensed again, but in this case by means of the second nozzle 19 to dispense the washing liquid 40 again in the direction of movement of wiper blade 14. The second wiper blade 14 in this state has reached the upper helical position 80 and remains at this position until the cleaning of the partial area 50 is completed.

FIG. 2d shows a state in which the first wiper blade 14 has once again reached the first end of the partial area 50, wherein upon reaching this position, a change of direction of the first wiper blade 14 is carried out again by means of the first wiper arm 12, and wherein the washing liquid 40 is again dispensed by means of the first nozzle 18.

FIG. 2e corresponds to the state described in FIG. 2c, which is why reference is made to FIG. 2c to avoid repetition.

FIG. 2f corresponds to the state described in FIG. 2d, which is why reference is made to FIG. 2d to avoid repetition.

FIG. 2g shows a state in which the soiling 90 (see FIG. 2a) was removed by means of the cleaning sequence according to the invention, but in which residues of the washing liquid 40 have remained on the windshield 30 due to the application of the washing liquid 40.

FIG. 2h shows a state in which the first wiper blade 14 is returned to the parking position by means of the first wiper arm 12 and the second wiper blade 114 by means of the second wiper arm 112. During the return of the two wiper blades 14, 114, the residues of the washing liquid 40 were removed from the windshield 30 by the wiper blades 14, 114.

FIG. 3 shows a schematic view of a second embodiment of a windshield wiper system according to the invention, wherein the windshield wiper system comprises a washing liquid reservoir 42 and a pump 120, which is configured to convey a washing liquid 40 from the washing liquid reservoir 42 to a plurality of valves 130, 132, 134, 136 as needed.

The valves 130, 132, 134, 136 are each configured to be individually controlled by means of an evaluation unit (not shown) in order to transport the washing liquid 40 to nozzles 18, 19, 118, 119 corresponding to the respective valves 130, 132, 134, 136 of respective corresponding wiper blades 14, 114, which are arranged on respective corresponding wiper arms 12, 112.

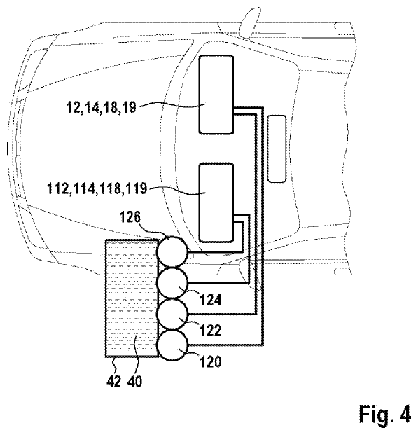

FIG. 4 shows a schematic view of a third embodiment of a windshield wiper system according to the invention, wherein the windshield wiper system comprises a washing liquid reservoir 42, a first pump 120, a second pump 122, a third pump 124, and a fourth pump 126, which are configured as needed to convey a washing liquid 40 from the washing liquid reservoir 42 individually to a plurality of nozzles 18, 19, 118, 119, which are arranged on a first wiper blade 14 and a second wiper blade 114, wherein the wiper blades 14, 114 are arranged on respective corresponding wiper arms 12, 112.

1. A windshield wiper system for a vehicle comprising:
a windshield wiper (10) comprising at least
a wiper arm (12),
a wiper blade (14),
a wiper arm drive (16), and
a washing nozzle (18), and
an evaluation unit (20),
wherein
the washing nozzle (18) is arranged in the area of the wiper blade (14) and is configured to be moved along a windshield (30) of the vehicle by means of the wiper arm (12) together with the wiper blade (14) and to dispense a washing liquid (40) in the vicinity of the wiper blade (14), and
the evaluation unit (20) is configured to
determine a partial area (50) of the windshield (30) of the vehicle to be cleaned by means of the windshield wiper system, wherein the partial area (50) is a partial area of an overall wiping area (60) which can be reached by the wiper blade (14),
control the wiper arm drive (16) in order to move the wiper blade (14) from an area of a parking position (70) of the wiper blade (14) to the determined partial area (50) of the windshield (30), and
activate the dispensing of the washing liquid (40) upon reaching the partial area (50) and control the wiper arm drive (16) to exclusively sweep the partial area (50) for cleaning by means of an oscillating movement.

2. The windshield wiper system according to claim 1, wherein the evaluation unit (20) is further configured to
determine a degree of wetting of the windshield (30) by a liquid in the area of the parking position (70) of the wiper blade (14), and
activate dispensing of a washing liquid (40) by means of the washing nozzle (18) in the area of the parking position (70) of the wiper blade (14) and then deactivate it again within the area of the parking position (70) when the degree of wetting is below a predefined threshold and not activate the dispensing of the washing liquid (40) in the area of the parking position (70) when the degree of wetting corresponds to at least the threshold value.

3. The windshield wiper system according to claim 1, wherein the evaluation unit (20) is configured to
deactivate the dispensing of the washing fluid (40) in the area of the parking position (70) of the wiper blade (14) after a predefined time and/or after sweeping over a predefined angle by the wiper arm (12) in the area of the parking position (70), and/or
adjust a pressure at which the washing fluid (40) is dispensed from the washing nozzle (18) as a function of a direction of movement of the wiper blade (14) and/or a type and/or an extent of soiling (90) present.

4. The windshield wiper system according to claim 2, wherein the degree of wetting of the windshield (30) in the area of the parking position (70) is determined based on
a rain sensor (140), and/or
a camera (100), and/or
weather data, and/or
a level of a current consumption of the wiper arm drive (16) and/or a driving speed of the vehicle.

5. The windshield wiper system according to claim 1, wherein
the partial area (50) to be cleaned is a predefined area and/or an area determined based on a sensor system (100, 140), and/or
the evaluation unit (20) is configured to determine a size of the partial area (50) to be cleaned as a function of an extent and/or type of soiling (90) present.

6. The windshield wiper system according to claim 1, wherein the evaluation unit (20) is configured to
move the wiper blade (14) back and forth multiple times within the partial area (50) by means of a control of the wiper arm drive (16) without exiting the partial area (50), and/or
to activate the dispensing of the washing liquid (40) within the partial area (50) permanently and/or several times in succession, and/or
a frequency of sweeping the partial area (50) by means of the wiper blade (14) and/or a frequency and/or duration of activation of the washing nozzle (18) within the partial area (50) and/or a wiping speed of the wiper blade (14) as a function
of predefined parameter, and/or
a type and/or an extent of a soiling (90) present in the partial area (50), and/or
a sensor-determined progress of the cleaning operation of the partial area (50), and/or
a type and/or an amount of precipitation present, and/or
an outside temperature, and/or
a driving speed, and/or
adjust a position of the soiling (90) on the windshield (30).

7. The windshield wiper system according to claim 1, wherein
the washing nozzle of the windshield wiper is a first washing nozzle (18),
the windshield wiper (10) comprises a second washing nozzle (19) arranged on an opposite side of the first washing nozzle (18) in the area of the wiper blade (14), such that the windshield wiper (10) is arranged to dispense a washing liquid (40) both in and against a current direction of movement of the wiper blade (14) based on the two washing nozzles (18, 19), and
the evaluation unit (20) is configured to individually activate the first washing nozzle (18) and the second washing nozzle (19) as a function of a respective direction of movement of the wiper blade (14) and/or a type and/or an extent of soiling (90) and/or individually adjust a dispensing pressure of the washing liquid (40).

8. The windshield wiper system according to claim 7, wherein the wiper system is configured to perform the individual activation of the first washing nozzle (18) and the second washing nozzle (19) based on separate washing liquid pumps (120, 122) and/or separate valves (130, 132) in respective feed lines of the washing nozzles (18, 19).

9. The windshield wiper system according to claim 1, wherein
the windshield wiper (10) comprises a further wiper arm (112) having a further wiper blade (114), a further wiper arm drive (116), and a further washing nozzle (118),
the evaluation unit (20) is configured to control the further wiper arm drive (116) and the further washing nozzle (118) to clean a further partial area.

10. The windshield wiper system according to claim 9, wherein the evaluation unit (20) is configured to move the wiper arm (12, 112) of the windshield wiper (10) in whose cleaning area no cleaning is currently required to an upper helical position (80) by means of a control of the corresponding wiper arm drive (16, 116) and leave it there until cleaning of the windshield (30) is completed by the other wiper arm (12, 112).
